(19) United States
(12) Patent Application Publication
(10) Pub. No.: US 2021/0300252 A1
(43) Pub. Date: Sep. 30, 2021

(54) Vehicular Rear Compartment Cover Mounted Cargo Assembly

(71) Applicant: Guy Fusco, Bandera, TX (US)

(72) Inventor: Guy Fusco, Bandera, TX (US)

(21) Appl. No.: 16/890,597

(22) Filed: Jun. 2, 2020

Related U.S. Application Data
(60) Provisional application No. 63/000,160, filed on Mar. 26, 2020.

(51) Int. Cl. B60R 5/04

(52) U.S. Cl. CPC B60R 5/041

(57) ABSTRACT

A cargo unit for installation at a cover of a utility space in a vehicle. The cover may be a spare tire cover with the unit configured to extend and retract to facilitate user friendly loading and unloading of cargo from the vehicle. The unit is lightweight and may remain in place even when lifting the cover to access items in the utility space such as the spare tire. Additionally, the entire unit may be removed from the vehicle without introducing undue damage to the vehicle installation area. Once more, the unit may be secured to a hitch receiver at the back of the vehicle with a tongue conveniently stowed between parallel reinforcement beams of the unit.

### PRIORITY CLAIM/CROSS REFERENCE TO RELATED APPLICATION(S)

This Patent Document claims priority under 35 U.S.C. § 119 to U.S. Provisional App. Ser. No. 63/000,160, filed Mar. 26, 2020, and entitled, “Rear Compartment Cover Mounted Cargo Mechanism”, which is incorporated herein by reference in its entirety.

### BACKGROUND

Vehicular transport of goods, equipment and personal items may be achieved in a variety of manners. Neighborhood delivery of everything from groceries to furniture is a common occurrence in today's society. Often commercial vans and large trucks are utilized. However, on the more personal side, trucks and SUV's (sport utility vehicles) are widely the choice of everyday commuters. This is in no small part due to the flexible offering of vehicle space that is available for accommodating a large amount of personal items, goods and equipment.

Trucks with open flatbeds are often utilized by everyday commuters. However, others prefer the option of an SUV which incorporates both added cargo space with the ability to close off access to rear cargo with a conventional hatchback or tailgate and rear window combination.

While open flatbed trucks are quite popular for commuting and accommodating a variety of different types of cargo, they do face a practical human limitation in terms of managing the cargo. More specifically, an open flatbed truck may often accommodate much more cargo than can be manually loaded or offloaded by a single person. Thus, if your friend helped you load the truck, hopefully that friend is interested in going where you're headed in order to unload the truck. Furthermore, the issue may be more complex. Perhaps the cargo is not necessarily so heavy as it is challenging to remove from the static location at the rear of the truck. For example, where the cargo is to be loaded or removed by an older individual or anyone for whom manually getting into the back of the truck is a significant obstacle, the challenge may not necessarily have much to do with the actual weight of the cargo.

Unfortunately, significant cargo challenges may also present when it comes to SUV's. For example, when opting for an SUV, the commuter may have the cargo stored more securely. However, the commuter is also sacrificing user friendly access to the goods and equipment that are accommodated within the rear of the vehicle. That is, unlike the rear of a truck, retrieving such goods from an SUV will require the opening of the hatchback or other door feature and reaching into, or sometimes crawling into, the back of the vehicle. Certainly the may become a significant challenge to those with certain physical limitations. Crawling around in the rear of an SUV may be even more difficult that getting into the back of a truck. Access may be easier when it comes to a truck. However, this still comes with the limitations noted above, in addition to leaving goods and equipment exposed and more accessible to others and the elements. Ultimately, avoiding the cargo related issues presented by an open flatbed truck by choosing an SUV may have done no more than present a whole new set of challenges for the commuter.

Some efforts have been undertaken to address the noted SUV cargo access issues. For example, an SUV may be equipped with an external cargo unit such as a carrier mounted at a tow hitch at the rear of the vehicle. In this way, goods and equipment that might be stored at the rear cargo location of the SUV may be moved to a more user-friendly location in terms of accessibility. Of course, the user friendliness here is limited. That is, while no longer potentially requiring the commuter to climb into the rear of the vehicle, the trade-off is the presence of a larger external unit stuck on the back of the vehicle. This presents an obstruction that renders parking the vehicle more challenging. The unit also can block access to the rear interior of the vehicle. That is, the hatchback is now hampered by a large obstruction extending from the back of the vehicle. Furthermore, the obstruction of the cargo unit is itself either under lock and key, largely defeating the user-friendly access objective or it is left insecure defeating the otherwise advantageous characteristic of SUV securability. Ultimately, regardless efforts to date, challenges presented by utilizing a truck for transport of cargo are simply not eliminated by opting for an SUV without presenting a whole new set of accessibility issues.

### SUMMARY

A cargo unit for installation in an SUV is disclosed. The unit includes hardware securable to a spare tire cover of the SUV rear cargo area. A platform is coupled to the hardware for extending from and retracting into the rear cargo area while accommodating articles for transport by the SUV.

### BRIEF DESCRIPTION OF THE DRAWINGS

Implementations of various structure and techniques will hereafter be described with reference to the accompanying drawings. It should be understood, however, that these drawings are illustrative and not meant to limit the scope of claimed embodiments.

FIG. 1 is a side cross-sectional view of an embodiment of a vehicular rear compartment cover mounted cargo assembly installed within a vehicle.

FIG. 2 is a top perspective view of the cargo assembly apart from installation in a vehicle.

FIG. 3 is a rear perspective view of the vehicle of FIG. 1 accommodating the assembly in an extended position for cargo accessibility.

FIG. 4 is a rear perspective view of the vehicle of FIG. 3 accommodating the assembly in a retracted position for cargo stowage.

FIG. 5 is a flow-chart summarizing an embodiment of utilizing a vehicular rear compartment cover mounted cargo assembly in a vehicle.

### DETAILED DESCRIPTION

Embodiments are described with reference to a cargo unit installed in an SUV. Specifically, the embodiments depict a unit that is secured to a spare tire cover within the rear cargo area of an SUV. However, other vehicle types such as station wagons may benefit from embodiments taught herein. Regardless, so long as the unit is securable to a tire cover and/or interchangeably securable to a hitch receiver, appreciable benefit may be realized.

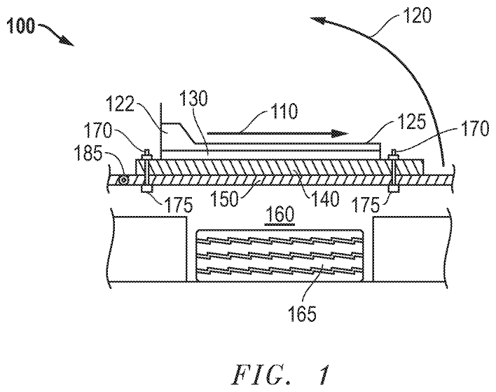

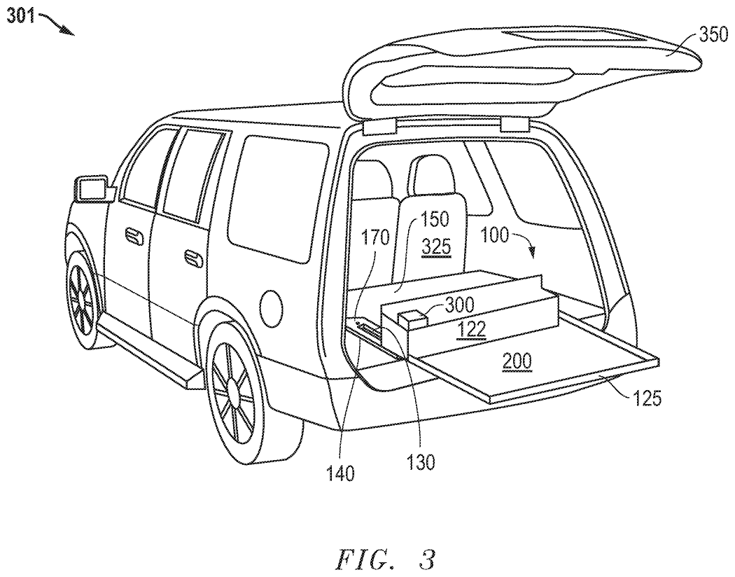

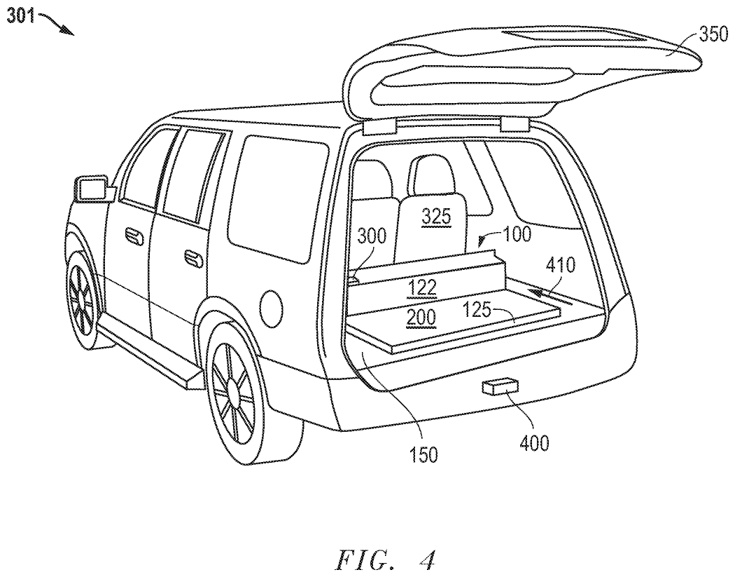

Referring now to FIG. 1, a side cross-sectional view of an embodiment of a vehicular rear compartment cover mounted cargo unit 100 is shown installed within a vehicle. Specifically, the unit 100 is secured to a spare tire cover 150 which generally serves as the floor of the cargo area (see the tire 165 within the utility space 160 below the cover 150). With brief added reference to FIGS. 3 and 4 a perspective overview of this area is illustrated with the cover 150 doubling as the floor of the cargo area. Returning to FIG. 1, the unit 100 is secured to the cover 150 with fasteners 170. In the embodiment shown, the fasteners 170 are bolts with a head 175 at one end and a wingnut at the other. Of course, any number of fastener types may be utilized.

It is worth noting that the unit 100 is installed at the somewhat unique location of the tire cover 150. That is, in contrast to a truck bed or other vehicle location, the tire cover 150 is a lightweight, less expensive and even replaceable item. Thus, the unit 100 is not being permanently installed at the expensive mainframe of a vehicle, potentially introducing damage thereto. Instead, discrete holes to accommodate fasteners 170 have been placed through a mere tire cover 150 providing a more easily removable system.

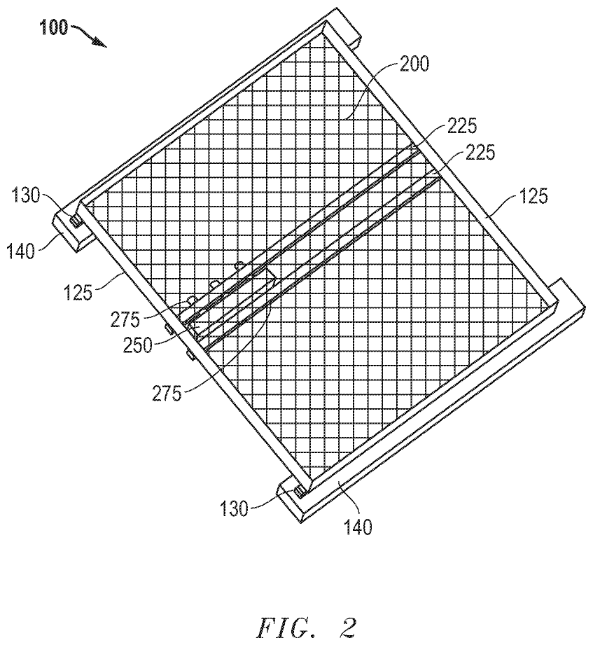

In addition to avoiding potentially permanent alteration to the steel frame of a vehicle upon installation, the unit 100 is also uniquely configured to be accommodated at the illustrated tire cover location. That is, as noted, the cover 150 may be relatively lightweight in contrast to the steel frame of a vehicle. Thus, the unit 100 is correspondingly lightweight itself, utilizing components constructed of a lightweight metal such as aluminum. For example, with added reference to FIG. 2, the floor 200 of the unit 100 may be commercially available wire mesh, perhaps no greater than ⅛ inch in thickness. However, conventional solid sheet metal may also be utilized.

Continuing with reference to FIGS. 1 and 2, the base 140 of the unit 100 which is secured to the cover 150 by the fasteners 170 may consist of two beams. Thus, not only is the interfacing of unit 100 with the cover 150 kept to a minimum but so too is the weight of the unit 100. By the same token, the use of two elongated beams for the base 140 allows for distribution of the weight of the unit 100 and any cargo to be distributed over a sufficient area to avoid concentrating weight at any isolated location of the cover 150. Indeed, the unit 100 may accommodate well over 100 lbs. of cargo without concern over damage to the cover 150 (or even the unit 100 itself).

In one embodiment, the entire unit 100 may take up between about 6-9 square feet of space but weigh less than 50 lbs. The specific size and dimensions may be tailored to the particular model SUV or other vehicle to accommodate the unit 100. Regardless, given that the unit 150 is only held in place by four discrete fasteners, as described further below, the option of removing the unit 100 entirely for securing at a tow hitch receiver 400 may be readily achieved.

Continuing with reference to FIG. 1, with added reference to FIG. 2, the lightweight of the unit 100 when empty should allow for lifting of the cover 150 about a hinge or pivot 185 without the need to remove the unit 100 (see arrow 120). Thus, the utility space 160 may be readily accessed. In the embodiment shown, cargo held by the unit 100 may be retained within sidewalls 125 and/or a raised compartment 122. Such a compartment may be located at any suitable location on the floor 200 of the unit 100. However, with added reference to FIG. 4, where the compartment 122 is present as shown, there may be interference by a car seat 325 when raising the cover 150. Nevertheless, lowering or moving the car seat 325 forward to remove the interference may be preferable to removing the unit 100 when accessing the utility space 160. In one embodiment, the compartment 122 is of a wire basket form corresponding to the lightweight nature of the unit 100.

The unit 100 is also equipped with extension tracks or slides 130 which may be conventional drawer glides or other suitable hardware to allow for moving of the unit 100 into an extended position (see arrow 110). With added reference to FIG. 3, the platform or tray which is made up of the floor 200, sidewalls 125 and container 120 is shown extended into the illustrated position for ease of loading or unloading cargo 300 (see also FIG. 2).

Referring now to FIG. 2, a top perspective view of the cargo unit 100 is illustrated apart from installation in a vehicle and absent the compartment 122 of FIG. 1. This perspective view reveals the manner in which the unit 100 is both lightweight and suitably stabilized and secure in design. For example, while the floor 200 is of a wire mesh, sidewalls 125 are provided that both help to retain cargo and provide supportive reinforcement to the floor 200 and unit 100. The sidewalls 125 may be aluminum. However, in an embodiment where added stability is desired, they may be of angle iron or other suitably more durable metal. Two of the sidewalls 125 are further reinforced by the base 140 and slides 130. In one embodiment, the angle iron utilized is of a 2 inch or 4 inch variety.

In addition to the reinforcing components described above, the unit 100 is also equipped with uniquely parallel beams 225. The beams 225 may be centrally located and of angle iron or other sturdy metal, tack welded in place as shown. Again, 2 inch or 4 inch varieties may be utilized. In addition to the reinforcement provided to the unit 100, the beams 225 are parallel and distanced from one another to provide a space for accommodating a tongue 250. The tongue 250 is of conventional size for being received by a hitch receiver 400 as shown in FIG. 4 and the space between the beams 225 is sized accordingly.

With the space between the beams 225 slightly wider than the tongue 250, conventional pins 275 are used to securely stow the tongue 250 thereat. With the orientation illustrated, the tongue 250 is merely secured at a convenient, user friendly location for potential later use. However, the tongue 250 may be re-oriented such that a hole therethrough to accommodate a pin at one end thereof is exposed. For example, in the embodiment shown, the pins 275 may be removed and the tongue 250 advanced or turned in the opposite direction such that it emerges from beyond the floor 200 of the unit 100. This may leave one pinhole location exposed with the other two locations available for reinsertion of the other two pins 275. Thus, the entire unit 100 may be removed and the tongue 250 aligned with and inserted into the hitch receiver 400 of FIG. 4. A hitch pin may then be used to secure the tongue 250 and the entire unit 100 in place as an external cargo assembly.

Referring now to FIG. 3, a rear perspective view of a vehicle 301 such as that referenced in FIG. 1 is shown accommodating the unit 300 in an extended position for accessibility of cargo 300. Specifically, with the rear hatch 350 open, the floor 200 of the unit 100 may be extended as illustrated. Cargo 300 in the form of groceries, sports drinks, tools, hay bales, dog food, livestock feed, camping gear, medical and mobility equipment or any other forms of cargo may be placed as shown. Ultimately, this cargo 300 which is fully accessible to a user standing outside of the vehicle 301 may be placed or retrieved as illustrated without the need for the user to reach far into the interior of the vehicle cargo area. Regardless of age, strength or any other practical limitation, the cargo 300, which was or will be stowed immediately behind the car seats 325, is nevertheless fully accessible to the user without any undue strain or exertion necessary. Simply extending the unit 100 to the position illustrated is all that is required to place or retrieve the cargo 300.

Continuing with reference to FIG. 3, the user may employ position locks to hold the extended unit 100 stably in place at between about 1 and 3 feet extended from the retracted position. With added reference to FIG. 2, such locks may consist of latches on the base 140 for catching pre-determined position holes at the sidewalls 125 or other suitable unit locations. Of course, pins or other securing means may also be utilized. Regardless, when placing or retrieving cargo 300, the tray is not prone to further extend or retreat. Therefore, user management of the cargo 300 may be a bit easier, particularly where the vehicle 301 is not parked on level ground. Of course, a position lock may also be utilized.

Referring now to FIG. 4, a rear perspective view of the vehicle 301 of FIG. 3 is shown accommodating the unit 100 in a retracted position for cargo stowage (see arrow 410). So, as noted above, the cargo 300 is now moved further into the interior of the vehicle 301 without the need for the user to personally access this depth of the interior. As with the extended position of FIG. 3, the retracted position may also utilize a position lock. Indeed, in the case of the retracted position, utilization of the lock to retain the retracted position may be particularly beneficial for when the hatch 350 is closed and the vehicle begins to move in transporting the cargo 300 and the user.

Continuing with reference to FIG. 4, note the location of the hitch receiver 400. Recall that the entire unit 400 may be uninstalled from the spare tire cover 150 and secured at the receiver 400 by merely reorienting the tongue 250 of FIG. 2.

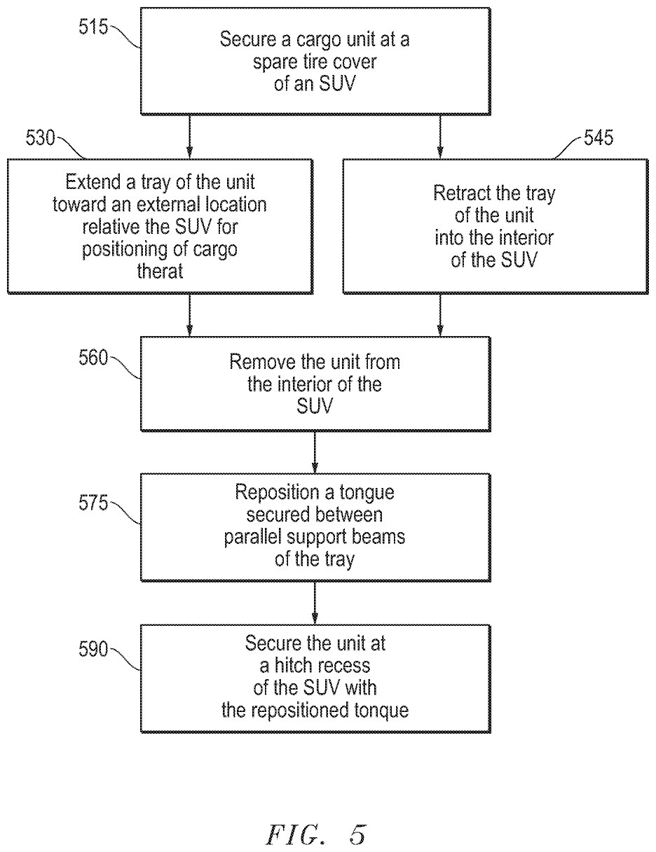

Referring now to FIG. 5, a flow-chart summarizing an embodiment of utilizing a vehicular rear compartment cover mounted cargo unit is illustrated. As indicated at 515, the cargo unit is configured for uniquely securing at a spare tire cover of an SUV. With the unit secured, a tray of the unit may be extended toward an external location away from the SUV. Thus, as noted at 530, cargo may be positioned from an external location such as by a user outside of the SUV loading or unloading cargo from the tray. Of course, as indicated at 545, the tray of the unit may also be retracted into the interior of the SUV for storing cargo or simply for returning the tray to a secure position.

In addition to the unique manner of securing the unit at a spare tire cover, the unit is also readily retrievable from the rear cargo compartment (see 560). Once more, a tongue secured between support beams of the unit may be repositioned for use as noted at 575. More specifically, as indicated at 590, the tongue may be positioned to extend from the unit for reception at a hitch recess of the SUV in order to provide an external cargo system.

Embodiments described hereinabove include an assembly which may be used externally as a carrier at a tow hitch as noted above. However, the assembly may also be securely retained at a unique location within the rear cargo location of the SUV. Further, the extendable nature of the assembly means that the user is provided direct access for positioning cargo without the need to climb into the cargo area of the vehicle. Further, since the assembly may be retracted back into the cargo area, the user friendly manner of positioning cargo does not come at the expense of leaving the cargo exposed at the exterior of the vehicle if this is not what the user desires. In short, the user is provided with an improved user-friendly manner of securing cargo but without requiring a trade-off requiring that the loaded cargo remain external to the vehicle cargo area. The assembly may be unlocked and readily used by the elderly, soccer moms, mechanics, handymen, carpenters, campers and even the physically impaired.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

1. A vehicle cargo system comprising:
a spare tire cover for a utility space in a rear cargo area of a vehicle; and
a unit weighing less than about 50 lbs. and rated to accommodate in excess of 100 lbs., the unit including a floor to accommodate cargo with a base for securing the unit directly to the cover and having at least one extension track interfacing the floor to the base to facilitate extending the floor away from and toward the cargo area.

2. The system of claim 1 wherein the vehicle is one of an SUV and a station wagon.

3. The system of claim 1 wherein the utility space accommodates a spare tire.

4. The system of claim 1 further comprising at least one fastener for the securing of the base.

5. The system of claim 4 wherein the at least one fastener is a wing nut fastener and the base comprises two spaced apart beams.

6. The system of claim 1 wherein the floor is comprised of aluminum that is one of a wire mesh and a solid sheet metal.

7. The system of claim 1 wherein the floor is a component of a tray of the unit, the tray further comprising:
raised sidewalls defining a perimeter of the tray; and
a raised compartment to separately accommodate cargo.

8. The system of claim 7 wherein the sidewalls are of angle iron and the raised compartment is a wire basket.

9. The system of claim 1 wherein the unit covers between about 6 and about 9 square feet.

10. (canceled)

11. The system of claim 1 further comprising centrally located parallel beams to reinforce the floor, the beams spaced apart a distance to accommodate a repositionable tongue therebetween, the tongue configured to support the unit at a hitch receiver of the vehicle.

12. A cargo unit for securing to a vehicle and comprising:
a floor of the unit inside the vehicle to accommodate cargo at a rear cargo area thereof within the vehicle;
a base securing the unit directly to a spare tire cover of the rear cargo area, the unit weighing less than about 50 lbs. and rated to accommodate in excess of about 100 lbs.;
parallel beams secured to the floor; and
a tongue secured between the parallel beams, the tongue repositionable to support the floor accommodating the cargo outside of the vehicle at a hitch receiver thereof.

13. The cargo unit of claim 12 wherein the parallel beams are centrally located relative the floor.

14. The cargo unit of claim 13 wherein the parallel beams are of 2-4 inch angle iron.

15. A method of positioning cargo in a vehicle, the method comprising:
securing a cargo unit weighing less than about 50 lbs. directly to an existing spare tire cover defining a utility space in a vehicle;
extending a tray of the unit toward an external location relative the vehicle for positioning in excess of about 100 lbs. of cargo thereat;
stably retracting the tray of the unit into the interior of the vehicle.

16. The method of claim 15 further comprising lifting the cover to access the utility space with the cargo unit secured thereto.

17. The method of claim 16 further comprising advancing a car seat away from the unit prior to lifting the cover.

18. The method of claim 15 further comprising removing the unit from the vehicle substantially avoiding damage thereto.

19. The method of claim 18 further comprising securing the unit to an external location of the vehicle at a hitch receiver thereof.

20. The method of claim 19 further comprising:
removing a tongue stored between parallel beams of the tray;
securing the tongue to the hitch receiver and to the beams for the securing of the unit to the external location.
